(19) United States
(12) Patent Application Publication
(10) Pub. No.: US 2016/0177050 A1
(43) Pub. Date: Jun. 23, 2016

(54) THERMOPLASTIC RESIN COMPOSITION, MOLDED ARTICLE MADE OF THE THERMOPLASTIC RESIN COMPOSITION, AND METHOD OF PREPARING THE THERMOPLASTIC RESIN COMPOSITION

(71) Applicant: Samsung Electronics Co., Ltd., Suwon-si (KR)

(72) Inventors: Namsoo Park, Suwon-si (KR); Chansu Kim, Seoul (KR); Jun Chwae, Seoul (KR); Kyunghae Lee, Incheon (KR); Seungjoon Hwang, Seoul (KR)

(21) Appl. No.: 14/834,110

(22) Filed: Aug. 24, 2015

(30) Foreign Application Priority Data
Dec. 22, 2014 (KR) 10-2014-0186371

(51) Int. Cl. C08K 3/20; C08L 67/04

(52) U.S. Cl. CPC C08K 3/20; C08L 67/04; C08L 2207/04

(57) ABSTRACT

A thermoplastic resin composition including: a polylactic acid; an inorganic nanostructure; and a chain extender, a molded article made of the thermoplastic resin, and a method of preparing the thermoplastic resin composition are disclosed.

### RELATED APPLICATION

This application claims the benefit of Korean Patent Application No. 10-2014-0186371, filed on Dec. 22, 2014, in the Korean Intellectual Property Office, the entire disclosure of which is hereby incorporated by reference.

### BACKGROUND

1. Field

The present disclosure relates to a thermoplastic resin composition, a molded article made of the thermoplastic resin composition, and a method of preparing the thermoplastic resin composition.

2. Description of the Related Art

In view of protecting the environment, interests in biodegradable resins, such as aliphatic polyesters, has increased. Among the biodegradable resins, polylactic acid (PLA) (or polylactide) has a high melting point between 160° C. to 170° C. and excellent transparency. In addition, lactic acid, as a raw material of PLA, may be obtained from renewable resources such as plants. Since degradation products of PLA are lactic acid, carbon dioxide, and water, which are harmless to the human body, PLA may be used in various applications including medical supplies.

PLA has poor impact resistance and heat resistance, compared with those of conventional resins including high impact polystyrene (HIPS) and acrylonitrile-butadiene-styrene (ABS). Thus, the improvement of impact resistance and heat resistance of PLA is required.

When a conventional impact modifier that improves impact resistance of PLA is used, the impact resistance of PLA may improve, but at the same time, the heat resistance of PLA may degrade. When a conventional heat modifier that improves heat resistance of PLA is used, the heat resistance of PLA may improve, but at the same time, the impact resistance of PLA may degrade.

Therefore, the simultaneous improvement of both heat resistance and impact resistance of PLA is required.

### SUMMARY

Provided is a thermoplastic resin composition comprising polylactic acid (PLA); an inorganic nanostructure; and a chain extender.

Also provided is a molded article made of the thermoplastic resin composition. Further provided is a method of preparing a thermoplastic resin composition, the method comprising: preparing a master batch comprising polylactic acid (PLA) and graphene oxide; and mixing the master batch with a chain extender.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a schematic view of the treatment of graphene oxide to provide a modified inorganic nanostructure as described in Preparation Example 2; and

FIG. 2 is a graph showing results of evaluating heat resistance of thermoplastic resin compositions prepared in Examples 2 to 4.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a thermoplastic resin composition, a molded article made of the thermoplastic resin composition, and a method of preparing the thermoplastic resin composition will be described in detail according to exemplary embodiments.

The terms “include” “contain” “includes,” “comprises,” and “comprises” as used herein means that a component or an ingredient of a subject matter is included without limitation in specific aspects of the invention, and that other additional components or ingredients of the subject matter are able to be added in addition to the component or the ingredient of the subject matter.

The term “lactide” used herein includes L-lactide composed of L-lactic acid, D-lactide composed of D-lactic acid, and meso-lactide composed of L-lactic acid and D-lactic acid.

The term “polylactic acid” (PLA) used herein refers to all polymers including a repeating unit that is formed by ring-opening polymerization of a lactide monomer or condensation polymerization of a lactic acid monomer. A polymer includes a homopolymer or a copolymer, and is not limited thereto. For example, the polymer includes unpurified or refined polymers prepared after ring-opening polymerization is completed, a polymer included in a liquid or solid resin composition before a product is molded; or a polymer included in plastics, films, or fabrics that are prepared after a product is completely molded.

The term “poly-L-lactic acid (PLLA)” used herein refers to a polymer including a repeating unit that is formed by ring-opening polymerization of an L-lactide monomer or condensation polymerization of an L-lactic acid monomer.

The term “poly-D-lactic acid (PDLA)” used herein refers to refers to a polymer including a repeating unit that is formed by ring-opening polymerization of a D-lactide monomer or condensation polymerization of a D-lactic acid monomer.

The term “inorganic nanostructure” used herein refers to a structure composed of one or more inorganic compounds and having at least one nanoscale dimension with a specific structure other than nanoparticle. The inorganic nanostructure may have a specific one dimensional structure such as nanofiber, nanotube or a specific two dimensional structure such as nanosheet, nanobelt.

The term “chain extender” used herein refers to a compound including at least one reactive functional group that is capable of extending a polymer chain by reacting with a polymer terminal or the like, or that is capable of connecting a plurality of polymer chains to each other. In the context of the thermoplastic composition, the chain extender may also couple to a polymer at one end and an inorganic compound of the inorganic nanostructure at the other end, thereby chemically connecting the polymer and the inorganic nanostructure to each other.

The term “thermoplastic resin” used herein refers to resin that increases its flexibility according to temperature.

According to an exemplary embodiment, a thermoplastic resin composition includes polylactic acid (PLA); an inorganic nanostructure; and a chain extender.

In the thermoplastic resin composition, the inorganic nanostructure may be uniformly dispersed in a PLA matrix, and accordingly the chain extender may adjust the spacing between the inorganic nanostructure dispersed in the PLA matrix by increasing or decreasing the space between the individual inorganic nanostructures and the surrounding PLA. In addition, in the thermoplastic resin composition, the chain extender may connect the inorganic nanostructures to PLA polymers, and connect the polymers to each other, thereby forming a network in the thermoplastic resin composition. The thermoplastic resin composition may have improved heat resistance compared, for instance, to a comparative resin that does not have such a structure, as set forth in the Examples.

In the thermoplastic resin composition, the inorganic nanostructure may be a carbonaceous nanostructure. The carbonaceous nanostructure refers to a carbonaceous structure having a nano-sized predetermined shape, and an example thereof may include a carbonaceous material having a nanorod, a nanosphere, a nanofiber, a nanobelt, or a nano-polyhedron structure. For example, the carbonaceous nanostructure may include a carbon nanotube (CNT), a carbon nanosphere (C₆₀), a carbon nanofiber, a carbon nanobelt, a carbon nanorod, a carbon nano-polyhedron, or a carbon nano-sheet.

For example, the carbonaceous nanostructure may be a two-dimensional (2D) carbonaceous nanostructure. The 2D carbonaceous nanostructure may be determined by the 2D horizontal and 2D vertical sizes of the nanostructure, wherein the size (e.g., thickness) other than the horizontal and vertical sizes of the 2D structure may be negligible. For example, the 2D nanostructure may be a nano-sized plane. The 2D nanostructure may be graphene.

In particular, the carbonaceous nanostructure may be a hydrophilic carbonaceous material, i.e., graphene oxide. The graphene oxide may be prepared by exfoliating graphite oxide. The graphene oxide may include a hydrophilic group, such as a hydroxyl group, a carboxyl group, or an ether group, on a surface thereof, and thus the hydrophilic group may react with a chain extender terminal or a PLA terminal to form a covalent bond.

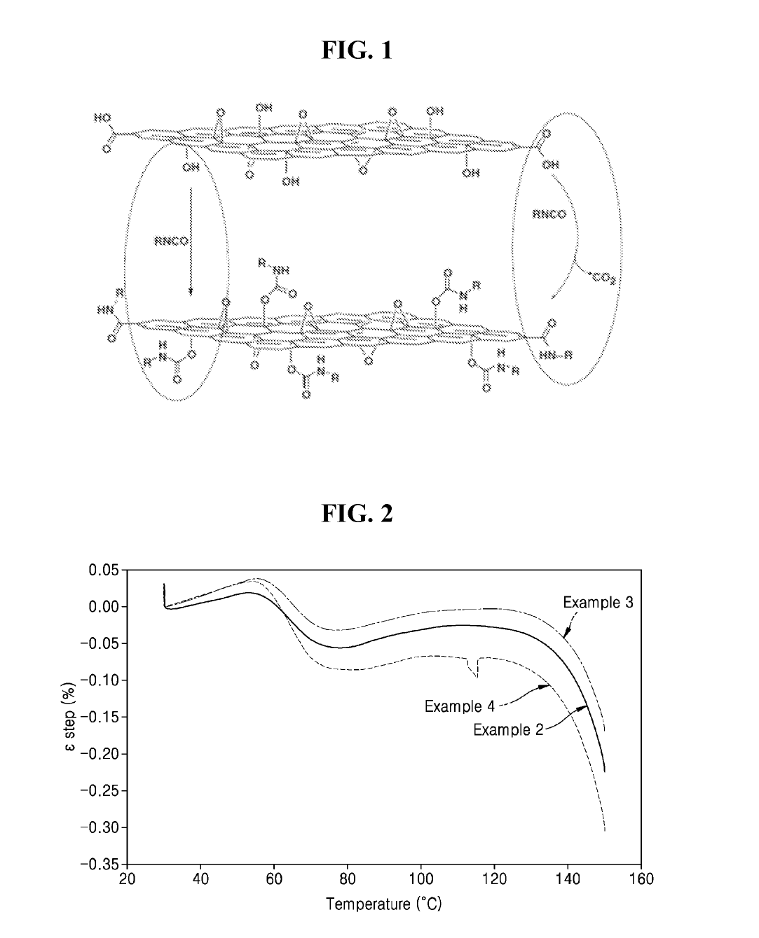

The thermoplastic resin composition may have a modified inorganic nanostructure that results from chemical bonding with the chain extender. For example, when the graphene oxide is covalently bonded with a reactive functional group of the chain extender, a modified graphene oxide, in which at least a portion of the surface of the graphene oxide is treated with the chain extender, may be obtained. As illustrated in FIG. 1, a carboxyl group or a hydroxyl group present on the surface of the graphene oxide may react with an isocyanate group (R—O—C≡N, abbreviated “RNCO” in FIG. 1), thereby obtaining a modified graphene oxide in which an isocyanate group-containing compound is bound to the surface of the graphene oxide. The modified graphene oxide may form a network structure that connects PLA and the inorganic nanostructure by forming an additional chemical bond with the PLA terminal.

The inorganic nanostructure can be used in any amount that provides the desired heat resistance and impact resistance. In the thermoplastic resin composition, a content of the inorganic nanostructure may be about 1 wt % or less with respect to a total weight of the thermoplastic resin composition. For example, the content of the inorganic nanostructure may be about 0.8 wt % or less with respect to the total weight of the thermoplastic resin composition. For example, the content of the inorganic nanostructure may be about 0.6 wt % or less with respect to the total weight of the thermoplastic resin composition. For example, the content of the inorganic nanostructure may be about 0.5 wt % or less with respect to the total weight of the thermoplastic resin composition. For example, the content of the inorganic nanostructure may be about 0.01 wt % or less with respect to the total weight of the thermoplastic resin composition. Generally, the content of the inorganic nanostructure may be about 0.05 wt % or more with respect to the total weight of the thermoplastic resin composition. For example, the content of the inorganic nanostructure may be about 0.05 wt % to 1 wt % based on the total weight of the thermoplastic resin composition. The inorganic nanostructure included within the ranges described above may provide a heat-resistant and impact-resistant thermoplastic resin composition. When the content of the inorganic nanostructure in the thermoplastic resin composition is excessively high, the inorganic nanostructures condense with each other, making it difficult to attain uniform dispersion. When the content of the inorganic nanostructure in the thermoplastic resin composition is excessively small, the effect of the inorganic nanostructure may be insignificant.

In the thermoplastic resin composition, the chain extender may be a monomer, an oligomer, or a polymer, each including at least one reactive functional group selected from a hydroxyl group, an amine group, an epoxy group, a glycidyl group, an isocyanate group, a carbodiimide group, and a carboxyl group. That is, the chain extender may be a monomer including a reactive functional group, an oligomer including a reactive functional group, or a polymer including a reactive functional group. The inclusion of a reactive functional group in the chain extender may enable a reaction with a hydrophilic group present on the surface of the inorganic nanostructure and/or a PLA terminal group, so as to form a binding therebetween.

The chain extender may include at least two reactive functional groups. The inclusion of at least two functional groups in the chain extender may enable the chain extender to bind with a plurality of inorganic nanostructures or a plurality of PLA terminal groups, and/or a binding between the inorganic nanostructure and the PLA terminal group, so as to connect to each other.

For example, the chain extender may be an aliphatic dicarboxylic acid compound, an aromatic dicarboxylic acid compound, an alicyclic dicarboxylic acid compound, or a diol compound.

The aliphatic dicarboxylic acid compound may be a compound represented by Formula 1 below:

HOOC—R₁—COOH <Formula 1>

In Formula 1, R₁ may be a covalent bond or a straight or branched C₁-C₂₀ alkylene group. For example, R₁ may be a straight C₁-C₁₅ alkylene group, a straight C₁-C₁₀ alkylene group, or a straight C₁-C₆ alkylene group.

The aromatic dicarboxylic acid compound may be a compound represented by Formula 2 below:

HOOC-A₂-Ar₁-A₁-COOH. <Formula 2>

In Formula 2, Ar₁ may be a C₆-C₂₀ arylene group or a C₂-C₂₀ heteroarylene group, and A₁ and A₂ may be a covalent bond or a straight or branched C₁-C₅ alkylene group. For example, Ar₁ may be a phenylene group, a naphthyl group, or a pyridyl group. At least one hydrogen of the arylene group and the heteroarylene group may be substituted with a halogen atom or a straight or a branched C₁-C₁₀ alkyl group.

The alicyclic dicarboxylic acid may be a compound represented by Formula 3 below:

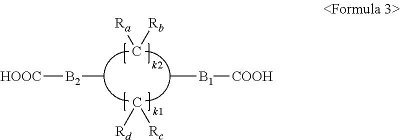

In Formula 3, Rₐ, R_{b}, R_{c}, and R_{d} may each independently be at least one selected from a hydrogen, a C₁-C₁₀ alkyl group, a C₆-C₁₀ aryl group, a C₆-C₁₀ cycloalkyl group, a C₂-C₁₀ alkenyl group, and a C₂-C₁₀ alkynyl group; B₁ and B₂ may each independently be a covalent bond or a C₁-C₅ alkylene group; and k₁ and k₂ may each independently be an integer selected from 1 to 20. For example, the dicarboxylic acid compound may be at least one selected from oxalic acid, malonic acid, succinic acid, glutaric acid, adipic acid, pimelic acid, suberic acid, azelaic acid, sebasic acid, phthalic acid, isophthalic acid, terephthalic acid, hexahydrophthalic acid, hexahydroisophthalic acid, naphthalene dicarboxylic acid, and furan-2,5-dicarboxylic acid.

The diol compound may be ethylene glycol, 1,2-propanediol, 1,3-propanediol, 1,4-butanediol, 1,5-pentanediol, 1,6-hexanediol, 1,7-heptane diol, 1,8-octane diol, 1,9-nonane diol, 1,10-decanediol, neopentyl glycol, diethylene glycol, polyethylene glycol, polypropylene glycol, polytetramethylene ether glycol, 1,2-cyclohexanediol, 1,4-cyclohexanediol, 1,2-cyclohexanedimethanol, or 1,4-cyclohexanedimethanol.

The chain extender may be at least one compound selected from 4,4′-diphenyl methane diisocyanate (MDI), 2,4- or 2,6-tolylene diisocyanate (TDI), 4,4′-dibenzyl diisocyanate, 1,3- or 1,4-phenylene diisocyanate, 1,5-naphthylene diisocyanate, zylene diisocyanate, ethylene diisocyanate, hexamethylene diisocyanate (HDI), lysine diisocyanate, isophorone diisocyanate(IPDI), 4,4′-dicyclohexylmethane diisocyanate, ethylene glycol, propylene glycol, 1,3-butylene glycol, 1,4-butanediol, 1,6-hexanediol, 3-methyl pentanediol, diethylene glycol, neopentyl glycol, 1,4-bis(hydroxylmethyl) cyclohexane, 1,4-bis(hydroxylethyl) benzene, 2,2-bis(4,4′-hydroxylcyclohexyl) propane, glycerin, trimethylolpropane, pentaerythritol, diglycerin, α-methylglucoside, sorbitol, zylitol, dipentaerythritol, glucose, fructose, sucrose, pyrogallol, hydroquinone, bisphenol A, bisphenol F, bisphenol S, ethylenediamine, hexamethylenediamine, diethylenetriamine, isophoron diamine, 4,4′-dicyclohexylmethane diamine, 4,4′-diaminodiphenylmethane, xylylene diamine, hydrazine, anhydrous succinic acid, anhydrous cyclohexane dicarboxylic acid, anhydrous phthalic acid, anhydrous maleic acid, anhydrous trimellitic acid, anhydrous pyromellitic acid, aryl glycidyl ether, stearic acid glycidyl ether, phenyl glycidyl ether, a bisphenol epoxy compound, a novolac epoxy compound, an epoxy-containing stylene-acrylic acid ester copolymer, (meta)acrylic acid glycidyl, modified phenylcarbodiimide, poly(tolyl carbodiimide), poly(4,4′diphenyl methanecarbodiimide), poly(3,3′-dimethyl-4,4′-biphenylene carbodiimide), polyparaphenylene carbodiimide, polymetaphenylene carbodiimide, and poly(3,3′-dimethyl-4,4′-diphenylmethane carbodiimide), but is not limited thereto. Any material available as a chain extender in the art may be used.

Any amount of the chain extender that provides the desired heat and impact resistance may be used. In the thermoplastic resin composition, a content of the chain extender may be about 2 wt % or less with respect to a total weight of the thermoplastic resin composition. For example, the content of the chain extender may be about 1.5 wt % or less with respect to the total weight of the thermoplastic resin composition. For example, the content of the chain extender may be about 1.2 wt % or less with respect to the total weight of the thermoplastic resin composition. For example, the content of the chain extender may be about 1.0 wt % or less with respect to the total weight of the thermoplastic resin composition. For example, the content of the chain extender may be about 0.01 wt % or less with respect to the total weight of the thermoplastic resin composition. Generally, the content of the chain extender may be about 0.05 wt % or more with respect to the total weight of the thermoplastic resin composition. For example, the content of the chain extender may be about 0.05 wt % to 2 wt % based on the total weight of the thermoplastic resin composition. The chain extender included within the ranges described above may provide a heat-resistant and impact-resistant thermoplastic resin composition. When the content of the chain extender is excessively high, overall properties of the thermoplastic resin composition may degrade. When the content of the chain extender is excessively small, the effect of the chain extender may be insignificant.

The thermoplastic resin composition may further include a thermoplastic polymer having a lower glass transition temperature Tg than that of PLA. The additional inclusion of the thermoplastic resin composition having a lower glass transition temperature Tg than that of PLA may further improve the impact resistance of the thermoplastic resin composition. In addition, the thermoplastic resin composition having a lower glass transition temperature Tg than that of PLA may include a structural unit derived from a monomer that may perform a molecular interaction with PLA, so as to induce increased impact resistance of the thermoplastic resin composition.

In the thermoplastic resin composition, a glass transition temperature Tg of PLA may be 50° C. or more. For example, a glass transition temperature Tg of poly-L-lactic acid (PLLA) may be from about 60° C. to about 65° C. In addition, a glass transition temperature Tg of the thermoplastic polymer having a lower glass transition temperature Tg than that of PLA may be about 40° C. or less. For example, a glass transition temperature Tg of the thermoplastic polymer having a lower glass transition temperature Tg than that of PLA may be about 30° C. or less. For example, a glass transition temperature Tg of the thermoplastic polymer having a lower glass transition temperature Tg than that of PLA may be about 10° C. or less. For example, a glass transition temperature Tg of the thermoplastic polymer having a lower glass transition temperature Tg than that of PLA may be about 0° C. or less. The inclusion of the thermoplastic polymer having a lower glass transition temperature Tg than that of PLA may enable the composition to more easily absorb external impact, thereby improving the impact resistance of the thermoplastic resin composition.

The thermoplastic polymer having a lower glass transition temperature Tg than that of PLA may be selected from an ethylene vinyl acetate copolymer; an ethylene (meta)acrylic acid ester copolymer; and an olefin-based polymer including at least one reactive functional group selected from an acid anhydride group, a carboxyl group, an amino group, an imino group, an alkoxysilyl group, a silanol group, a silyl ether group, a hydroxyl group, and an epoxy group.

In the thermoplastic resin composition, the thermoplastic polymer having a lower glass transition temperature Tg than that of PLA may an olefin-based thermoplastic polymer. The olefin-based thermoplastic polymer may refer to a polymer including a repeating unit that is derived from an olefin-based monomer. The olefin-based thermoplastic polymer may be a copolymer of an olefin-based monomer and a monomer that is different from the olefin-based monomer. In the olefin-based thermoplastic polymer, the olefin-based monomer may be ethylene, propylene, butadiene, or styrene. In the olefin-based thermoplastic polymer, a monomer that is different from the olefin-based monomer may be, e.g., vinyl acetate, acrylate, acrylic acid, or glycidyl anhydride, but is not limited thereto. Any material available as a monomer that performs a molecular interaction with PLA in the art may be used.

For example, the thermoplastic polymer having a lower glass transition temperature Tg than that of PLA may be an ethylene vinyl acetate copolymer including a structural unit of ethylene in a range from about 60 wt % to about 75 wt % and a structural unit of vinyl acetate in a range from about 25 wt % to about 40 wt %. The structural unit of vinyl acetate included within the ranges described above may provide a thermoplastic resin composition having improved impact resistance. When the content of the structural unit of vinyl acetate is excessively small, a molecular interaction with PLA may not be easily performed, and accordingly, a basic structure of the PLA matrix may not be enhanced. When the content of the structural unit derived from vinyl acetate is excessively high, the compatibility with the PLA matrix may be increased, and accordingly, impact strength may be further increased. Here, since the softness of a PLA composition also increases, there may be disadvantages to increase the heat resistance of the thermoplastic resin composition.

In the thermoplastic resin composition, a content of the thermoplastic polymer having a lower glass transition temperature Tg than that of PLA may be in a range from about 5 wt % to about 20 wt % with respect to a total weight of the thermoplastic resin composition. For example, the content of the thermoplastic polymer may be in a range from about 5 wt % to about 15 wt % with respect to the total weight of the thermoplastic resin composition. For example, the content of the thermoplastic polymer may be in a range from about 7 wt % to about 13 wt % with respect to the total weight of the thermoplastic resin composition. For example, the content of the thermoplastic polymer may be in a range from about 8 wt % to about 12 wt % with respect to the total weight of the thermoplastic resin composition. The thermoplastic polymer included within the ranges described above may provide a thermoplastic resin composition having improved heat resistance and impact resistance. When the content of the thermoplastic polymer having a lower glass transition temperature Tg than that of PLA is excessively small, the impact resistance of the thermoplastic resin composition may degrade. When the content of the thermoplastic polymer having a lower glass transition temperature Tg than that of PLA is excessively high, due to the occurrence of phase separation, the impact resistance and overall properties of the thermoplastic resin composition may degrade.

The thermoplastic resin composition may include any amount of PLA needed to impart the desired properties. For example, the composition may comprise PLA in a range from about 79 wt % to about 92 wt %, the thermoplastic polymer in a range from about 5 wt % to about 20 wt %, the inorganic nanostructure in a range from about 0.1 wt % to about 1 wt %, and the chain extender in a range from about 0.1 wt % to about 2 wt %. The thermoplastic resin composition prepared within the ranges described above may have improved heat resistance and impact resistance.

In the thermoplastic resin composition, the PLA may be poly-L-lactic acid (PLLA) including a repeating unit that is represented by Formula 4 below:

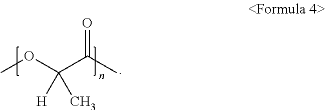

Acidity of the PLLA may be about 50 meq/kg or less. The acidity of the PLLA is not particularly limited thereto, but within this range, the PLLA may provide improved properties of the thermoplastic resin composition. For example, the acidity of the PLLA may be in a range from about 1 meq/Kg to about 50 meq/Kg. For example, the acidity of the PLLA may be in a range from about 1 meq/Kg to about 30 meq/Kg. For example, the acidity of the PLLA may be in a range from about 1 meq/Kg to about 10 meq/Kg. For example, the acidity of the PLLA may be in a range from about 2 meq/Kg to about 5 meq/Kg.

A weight average molecular weight of the PLLA may be in a range from about 10,000 Daltons to about 500,000 Daltons. For example, the weight average molecular weight of the PLLA may be in a range from about 10,000 Daltons to about 300,000 Daltons. When the weight average molecular weight of the PLLA is less than 10,000 Daltons, mechanical properties of the thermoplastic resin composition may degrade. When the weight average molecular weight of the PLLA is greater than 500,000 Daltons, the processing of the thermoplastic resin composition may be difficult. As a result of gel permeation chromatography (GPC) analysis, a weight-average molecular weight of the PLLA can be determined. The GPC analysis can be performed using polystyrene as a standard and tetrahydrofuran as a solvent.

Optical purity of the PLLA may be at least 90%. For example, the optical purity of the PLLA may be at least 93%. For example, the optical purity of the PLLA may be at least 95%. For example, the optical purity of the PLLA may be at least 97%. When the optical purity of the PLLA is 90% or less, mechanical properties of the thermoplastic resin composition may degrade.

The thermoplastic resin composition may have an Izod impact strength of at least 90 J/m and a heat distortion temperature (DMA) of at least 50° C. For example, the Izod impact strength of the thermoplastic resin composition may be at least 120 J/m and the DMA of at least 80° C. For example, the Izod impact strength of the thermoplastic resin composition may be at least 130 J/m and the DMA thereof may be at least 100° C. For example, the Izod impact strength of the thermoplastic resin composition may be at least 140 J/m and the DMA thereof may be at least 110° C.

The thermoplastic resin composition may a liquid or a solid. The thermoplastic resin composition may be a composition prepared before a final product is molded, or a molded article, a film, or a fabric prepared after a final product is molded. The molded article, the film, or the fabric prepared after the molding may be prepared by using conventional methods according to the shape of each product.

The thermoplastic resin composition may further include an additive that is typically used in a conventional resin composition as described below.

For example, the additive may be a filler, a terminal blocking agent, a metal deactivator, an antioxidant, a heat stabilizer, an ultraviolet (UV) absorbent, a lubricant, a tackifier, a plasticizer, a cross-linking agent, a viscosity adjusting agent, an antistatic agent, a flavoring agent, an antibacterial agent, a dispersant, or a polymerization inhibitor, so long as the additive does not adversely influence properties of the resin composition.

In addition, the thermoplastic resin composition may include a filler. The filler may be, e.g., an inorganic filler, such as talc, wollastonite, mica, mud, montmorillonite, smectite, kaolin, zeolite (i.e., aluminum silicate), or anhydrous amorphous aluminum silicate prepared by acid-treating and heat-treating zeolite. When the filler is included, a content of the filler in the thermoplastic resin composition may be in a range from about 1 wt % to about 20 wt % with respect to a total weight of the thermoplastic resin composition, so as to maintain the heat resistance and impact resistance of the molded article.

The thermoplastic resin composition may include, as a terminal blocking agent, a carbodiimide compound, such as a polycarbodiimide compound or a monocarbodiimide compound. The compound used as the terminal blocking agent may partially or completely react to a carboxyl group terminal of the PLA resin, and accordingly, a side reaction, such as hydrolysis, is blocked, thereby improving water resistance of the molded article including the thermoplastic resin composition. Thus, the molded article including the thermoplastic resin composition may have improved durability under high temperature and high humidity environment.

The polycarbodiimide compound may be, e.g., poly(4,4′-diphenylmethane carbodiimide), poly(4,4′-dicyclohexylmethane carbodiimide), poly(1,3,5-triisopropylbenzene) polycarbodiimide, or poly(1,3,5-triisopropylbenzene and 1,5-diisopropylbenzene) polycarbodiimide. The monocarbodiimide compound may be, e.g., N,N′-di-2,6-diisopropylphenyl carbodiimide.

A content of the carbodiimide compound may be in a range from about 0.1 wt % to about 3 wt % with respect to a total weight of the thermoplastic resin composition. When the content of the carbodiimide compound is less than 0.1 wt %, the durability of the molded article may be insignificantly improved. When the content of the carbodiimide compound is greater than 3 wt %, the mechanical strength of the molded article may degrade.

The thermoplastic resin composition may include a stabilizer or a coloring agent to stabilize a molecular weight or color at the time of a molding process. As a stabilizer, a phosphorus stabilizer, a hindered phenolic stabilizer, a UV absorbent, a heat stabilizer, or an antistatic agent may be used.

As a phosphorus stabilizer, phosphorous acid, phosphoric acid, phosphonic acid, and esters thereof (e.g., a phosphite compound, a phosphate compound, a phosphonite compound, and a phosphonate compound), or tertiary phosphine may be used

As a stabilizer having a phosphonite compound as a main ingredient, Sandostab P-EPQ (Clariant) or Irgafos P-EPQ (CIBA SPECIALTY CHEMICALS) may be used.

As a stabilizer having a phosphate compound as a main ingredient, PEP-8 (Asahi Denka Kogyo), JPP681S (Tohoku Chemical Co., Ltd.), PEP-24G (Asahi Denka Kogyo), Alkanox P-24 (Great Lakes), Ultranox P626 (GE Specialty Chemicals), Doverphos S-9432 (Dover Chemical), Irgaofos126, 126 FF (CIBA SPECIALTY CHEMICALS), PEP-36 (Asahi Denka Kogyo), PEP-45 (Asahi Denka Kogyo), or Doverphos S-9228 (Dover Chemical) may be used.

A hindered phenolic stabilizer (i.e., an antioxidant) may be a typical compound that is mixed with a conventional resin. The hindered phenolic stabilizer may be, e.g., 3,9-bis[2-{3-(3-t-butyl-4-hydroxyl-5-methylphenyl)propionyloxy}-1,1-dimethylethyl]-2,4,8,10-tetraoxaspiro[5,5]undecane, but is not limited thereto. Any hindered phenolic compound available as an oxidation stabilizer of a resin composition in the art may be used.

In the thermoplastic resin composition, amounts of the phosphorous stabilizer and the hindered phenolic antioxidant may be in a range from about 0.005 wt % to about 1 wt % with respect to a total weight of the thermoplastic resin composition.

The thermoplastic resin composition may include a UV absorbent. The inclusion of a UV absorbent may inhibit degradation of weather resistance of the molded article that is influenced by a rubber component or a flame retardant. As a UV absorbent, a benzophenone-based UV absorbent, a benzotriazole-based UV absorbent, a hydroxylphenyl triazine UV absorbent, a cyclic iminoester-based UV absorbent, and a cyanoacrylate-based UV absorbent may be used. In the thermoplastic resin composition, a content of the UV absorbent may be in a range from about 0.01 wt % to about 2 wt % with respect to a total weight of the thermoplastic resin composition.

The thermoplastic resin composition may include, as a coloring agent, a dye or a pigment to provide a variety of colors to the molded article.

The thermoplastic resin composition may include an antistatic agent to provide antistatic capability to the molded article.

The thermoplastic resin composition may include, in addition to the materials described above, a thermoplastic resin, a flow modifier, an antibacterial agent, a dispersing agent, such as liquid paraffin, a photocatalytic agent-based contaminating agent, a heat-ray absorbent, and a photochromic agent.

According to another exemplary embodiment, a molded article may be formed of the thermoplastic resin composition described above.

Regarding each individual component of the thermoplastic resin composition, some of the components may be prepared in a form of a master batch according to a reactive compounding process or a melting compounding process using various extruders, Banburry mixers, kneaders, continuous kneaders, or rolls. During such a compounding process, each individual component of the thermoplastic resin composition may be added at once or in a divisional manner. Alternatively, each individual component of the thermoplastic resin composition may be prepared by removing a solvent after being melted and mixed in the solvent. The thermoplastic resin composition prepared in this manner may obtain a molded article according to molding methods known in the art, such as an injection molding method, a press molding method, a calendar molding method, a T-die extrusion molding method, a hollow sheet extrusion molding method, a foam sheet extrusion molding method, an inflation molding method, a lamination molding method, a vacuum molding method, a profile extrusion molding method, or a combination thereof.

When a device used for the calendar molding method, the T-die extrusion molding method, or the inflation molding method is connected with a kneading device, such as a kneading extruder or a Banburry mixer, the thermoplastic resin composition was obtained first. Instead, the thermoplastic resin composition may be obtained by using the device connected with the kneading device, and at the same time, a molded article may be prepared therefrom.

The molded article prepared by using thermoplastic resin composition may be used in various applications without limitation. For example, the molded article may be used for medical purposes, such as a vascular graft, cell carriers, drug carriers, or gene carriers. In addition, the molded article may be used as an internal or external covering material of various types of general-purpose products. For example, the molded article may be as an internal or external covering material of home appliances, communication devices, or industrial equipment. In addition, the molded article may be used for general-purpose products including a case, such as a relay case, a wafer case, a reticle case, or a mask case; a tray, such as a liquid tray, a chip tray, a hard disk tray, a CCD tray, an IC tray, an organic EL tray, an optical pickup tray, or an LED tray; a carrier, such as an IC carrier; a film, such as a polarizing film, a light guide plate, a protective film used in various lenses, or a sheet, such as a partition board used in a clean room; a member related to various types of components to be returned, such as a case to be returned including an antistatic bag used in an internal member of a vending machine, a liquid panel, a hard disk, or a plasma channel, a plastic corrugated cardboard, a liquid panel, a liquid cell, or a plasma channel.

According to another exemplary embodiment, a method of preparing the thermoplastic resin composition may include: preparing a master batch including PLA and graphene oxide; and mixing the master batch, the PLA, the thermoplastic polymer having a lower glass transition temperature Tg than that of the PLA, and the chain extender.

For example, the master batch including the PLA and the graphene oxide may be used to mix graphene oxide ink in which the graphene oxide is dispersed and a solution in which the PLA is dissolved, thereby preparing a mixed solution. Afterwards, the mixed solution is stirred, and the PLA in which the graphene oxide is dispersed may be precipitated. Thus, in the master batch, the graphene oxide may be dispersed homogeneously within the PLA matrix.

Next, the master batch, the PLA, the thermoplastic polymer having a lower glass transition temperature Tg than that of the PLA, and the chain extender are mixed together, so as to prepare a thermoplastic resin composition.

The preparation of the thermoplastic resin composition may be performed by both a melt blending method and a solution blending method. In the case of the solution blending method, the master batch, the PLA, the thermoplastic polymer having a lower glass transition temperature Tg than that of the PLA, and the chain extender may be added and melted in an organic solvent, such as toluene, tetrahydrofuran, or chloroform, at a predetermined ratio. Then, the solvent may be removed through heat treatment and under reduced pressure, so as to prepare a resin composition. In the case of the melt blending method, the master batch, the PLA, the thermoplastic polymer having a lower glass transition temperature Tg than that of the PLA, and the chain extender may be prepared by using a mechanical stirrer, such as a kneading machine or a single or twin extruder, at a temperature higher than a melting point of the PLA.

For example, the mixing of the master batch, the PLA, the thermoplastic polymer having a lower glass transition temperature Tg than that of the PLA, and the chain extender may be performed according to a melt compounding process or a reactive compounding process.

For example, the mixing of the master batch, the PLA, the thermoplastic polymer having a lower glass transition temperature Tg than that of the PLA, and the chain extender may be performed in a kneading extruder at a temperature in a range from about 190° C. to about 230° C. at a rate in a range from about 10 rpm to about 100 rpm.

The graphene oxide may be prepared as follows:

First, graphite is in contact with strong acid to allow oxidation, so as to obtain graphite oxide in which hydrophilic groups are injected between graphene layers of the graphite. Next, the graphite oxide may be subjected to exfoliation using ultrasonic waves, thereby obtaining graphene oxide that is exfoliated into individual graphene layers. For example, in the order as illustrated in FIG. 1, the graphene oxide in which a hydrophilic group is bonded to the surface thereof may be prepared, wherein the hydrophilic group includes a hydroxyl group (—OH) or a carboxyl group (—COOH). In x-ray photoelectron spectroscopy regarding the graphene oxide used in the preparation method above, a content ratio of carbon to oxygen (C/O ratio) may be 3 or less. That is, the binding of the hydrophilic group to the surface of the graphene oxide may significantly increase a content of oxygen compared to that of pure graphite.

Hereinafter, one or more embodiments will be described in more detail with reference to the following examples. However, these examples are for illustrative purposes only and are not intended to limit the scope of the one or more embodiments.

Preparation of Graphene Oxide

### Preparation Example 1

### Graphene Oxide

In a reactor, 2.5 g of graphite was mixed with 100 ml of sulfuric acid, and the mixture was maintained at a temperature of 0° C. for 30 minutes, and then, 2.5 g of sodium nitrate (NaNO₃) was added thereto and stirred at a temperature of 0° C. for 30 minutes to allow a reaction. Then, at a low temperature, 7.5 g of potassium permanganate (KMnO₄) was added to the reactor, and the mixture was stirred for 30 minutes to allow a reaction. At room temperature, the mixture was stirred again for 12 hours to allow an additional reaction. When the mixture was confirmed to have a greenish black reaction color during the reaction, the oxidation reaction was terminated. 300 ml of distilled (DI) water was added thereto, and then, was left as it is for 1 hour. Then, 50 ml of DI water was additionally added thereto, and 6 ml of hydrogen peroxide (H₂O₂, 30 wt %) was also added thereto to allow a reaction for 1 hour to occur, thereby terminating the oxidation reaction. After the reaction was terminated, the reaction solution was left as it is to remove supernatant therefrom. Next, new DI water was added to the reaction solution from which the supernatant was removed, so as to precipitate graphite oxides using a centrifuge, and then, supernatant was removed again therefrom. DI water was added again to the reaction solution, so as to purify graphite oxides. A membrane filter was used to separate graphite oxides, and then, the separated graphite oxides were vacuum-dried to obtain graphite oxide powder. Here, the graphite oxide powder included at least a portion of the graphene oxide.

### Preparation Example 2

### PLA-Graphene Oxide Master Batch

0.5 g of graphite oxide powder of Preparation Example 1 was mixed with 10 ml of anhydrous dimethyl formamide (DMF) in a 250 ml flask equipped with a stirrer, a heating device, a condenser, and a vacuum device under a nitrogen atmosphere, and then, the mixture was subjected to a sonication treatment for at least 30 minutes to allow dispersion to occur, thereby preparation graphite oxide ink. The graphite oxide was mostly separated into graphene oxide upon the sonication treatment. 5 g of PLA (NatureWorks 4032D) was dissolved in chloroform, and then, the graphene oxide ink was added thereto to prepare a mixed solution. For a predetermined period of time, the mixed solution was subjected to mechanical stirring, so as to uniformly disperse the graphene oxide. Here, the mechanical stirring was performed at room temperature or at a temperature in a range from about 30° C. to about 60° C. Next, the mixed solution was mixed with methanol to allow precipitation to occur, and the resultant precipitates were filtered using a filter and dried in a vacuum oven at a temperature of 40° C. to remove methanol therefrom, thereby obtaining a solid PLA-graphene oxide master batch. When precipitated in methanol, a homogenizer was used to obtain a master batch in the form of grey-to-black powder.

Preparation of Thermoplastic Resin Composition

### Example 1

### GO+HMDI+EVA+PLLA, GO 1 wt %

38.5 g of PLLA (NatureWorks 4032D) was mixed with 5 g of poly(ethylene-co-vinyl acetate, VA 40 wt %, Sigma-Aldrich Co., Ltd.), 1 g of hexamethylene diisocyanate (HMDI, Sigma-Aldrich Co., Ltd.), and 5.5 g of the PLA-graphene oxide master batch of Preparation Example 1. Then, the mixture was subjected to a reactive compounding process using a small extruder (twin screw extruder, Thermo Scientific Co. Ltd.) under conditions of an extrusion temperature of 200° C. and an extrusion rate of 70 rpm, thereby preparation a thermoplastic resin composition including 1 wt % of graphene oxide.

As illustrated in FIG. 1, during the reactive compounding process, an isocyanate group of MDI (represented by “RCNO”) reacted with a hydrophilic group of the graphene oxide to form a chemical bond therebetween, thereby obtaining a modified graphene oxide. In addition, another isocyanate group of MDI reacted with PLA to form an additional bond therebetween (not shown in FIG. 1).

### Example 2

### GO+HMDI+EVA+PLLA, GO 0.5 wt %

A thermoplastic resin composition was prepared in the same manner as in Example 1, except that the content of graphene oxide was changed to 0.5 wt %.

### Example 3

### GO+HMDI+EVA+PLLA, GO 0.25 wt %

A thermoplastic resin composition was prepared in the same manner as in Example 1, except that the content of graphene oxide was changed to 0.25 wt %.

### Example 4

### GO+HMDI+EVA+PLLA, GO 0.1 wt %

A thermoplastic resin composition was prepared in the same manner as in Example 1, except that the content of graphene oxide was changed to 0.1 wt %.

### Comparative Example 1

### PLLA Only

PLLA (NatureWorks 4032D) was melted at a temperature of 210° C. using a small injection device (Haaket Minijet, Thermo Scientific Co. Ltd.), and then, crystallized at a molding temperature of 100° C., thereby obtaining a thermoplastic resin composition.

### Comparative Example 2

### GO+PLLA, GO 1 wt %

44.5 g of PLLA (NatureWorks 4032D) was mixed with 5.5 g of the PLA-graphene oxide master batch of Preparation Example 1. Then, a small extruder (twin screw extruder, Thermo Scientific Co. Ltd.) was used to perform a reactive compounding process under conditions of an extrusion temperature of 200° C. and an extrusion rate of 70 rpm, thereby manufacturing a thermoplastic resin composition including 1 wt % of graphene oxide.

### Comparative Example 3

### GO+PLLA, GO 0.5 wt %

A thermoplastic resin composition was prepared in the same manner as in Example 1, except that the content of graphene oxide was changed to 0.5 wt %.

### Comparative Example 4

### Talc+PLLA, Talc 1.0 wt %

49.5 g of PLLA (NatureWorks 4032D) was mixed with 0.5 g of ultratalc. The mixture was melted at a temperature of 210° C. using a small injection device (Haaket Minijet, Thermo Scientific Co. Ltd.), and then, crystallized at a molding temperature of 100° C., thereby obtaining a thermoplastic resin composition including 1 wt % of ultratalc.

### Comparative Example 5

### Talc+PLLA, Talc 2.0 wt %

A thermoplastic resin composition was prepared in the same manner as in Example 4, except that the content of ultratalc was changed to 2 wt %.

### Comparative Example 6

### EVA 10 wt %+PLLA

45 g of PLLA (NatureWorks 4032D) was mixed with 5 g of poly-ethylene-co-vinyl acetate, VA 40 wt %, Sigma-Aldrich Co., Ltd.), and then, the mixture was subjected to a reactive compounding process using a small extruder (twin screw extruder, Thermo Scientific Co. Ltd.) under conditions of an extrusion temperature of 200° C. and an extrusion rate of 70 rpm, thereby manufacturing a thermoplastic resin composition.

### Comparative Example 7

### HMDI+EVA 10 wt %+PLLA

44 g of PLLA (NatureWorks 4032D) was mixed with 5 g of poly-ethylene-co-vinyl acetate (VA 40 wt %, Sigma-Aldrich Co., Ltd.) and 1 g of HMDI (Sigma-Aldrich Co., Ltd.). Then, the mixture was subjected to a reactive compounding process using a small extruder (twin screw extruder, Thermo Scientific Co. Ltd.) under conditions of an extrusion temperature of 200° C. and an extrusion rate of 70 rpm, thereby manufacturing a thermoplastic resin composition.

### Comparative Example 8

### Talc+EVA+PLLA

44.5 g of PLLA (NatureWorks 4032D) was mixed with 5 g of poly(ethylene-co-vinyl acetate, VA 40 wt %, Sigma-Aldrich Co., Ltd.) and 0.5 g of ultra talc. Then, the mixture was subjected to a reactive compounding process using a small extruder (twin screw extruder, Thermo Scientific Co. Ltd.) under conditions of an extrusion temperature of 200° C. and an extrusion rate of 70 rpm, thereby manufacturing a thermoplastic resin composition including 1 wt % of ultra talc.

### Comparative Example 9

### ABS Only

Acrylonitrile-butadiene-styrene (ABS) copolymer (LG chemical Co. Ltd.) was melted at a temperature of 210° C. using a small injection device (Haaket Minijet, Thermo Scientific Co. Ltd.), and then, crystallized at a molding temperature of 100° C., thereby obtaining a thermoplastic resin composition.

### Evaluation Example 1

### Thermogravimetry Analysis (TGA)

The graphite used as a starting material in Preparation Example 1 and the graphene oxide of Preparation Example 1 were subjected to TGA using a TGA measuring analyzer (TA Instrument Discovery series) under conditions of a heating rate of 10° C./minutes and at a temperature up to 1000° C. in a nitrogen atmosphere, so as to measure changes in weight.

The graphite used as a starting material in Preparation Example 1 showed a weight loss of about 1% when heated up to a temperature of 1000° C. However, the graphene oxide of Example 1 showed a weight loss of about 49.2% when heated at a temperature in a range from about 80˜100° C. to about 430˜450° C. Such a weight loss was determined to occur due to moisture present in a sample and dehydration and thermal decomposition of a hydrophilic group, such as a hydroxyl group (—OH) and a carboxyl group (—COOH), present on the surface of the graphene oxide. Here, a peak value of a temperature at which the thermal decomposition of the hydrophilic group was occurred was about 167° C.

### Evaluation Example 2

### X-Ray Photoelectron Spectroscopy (XPS)

Kratos company's model, Axis XPS, was used to measure a content ratio of carbon to oxygen in the graphene oxide under conditions of monochromatic Al-Kα (hv=1486.6 eV) radiation.

A content ratio of carbon/oxygen (C/O) in the graphite used as a starting material in Preparation Example 1 was at least 95. A content ratio of C/O in the graphene oxide of Preparation Example 1 was in a range from about 2.73 to about 2.82.

### Evaluation Example 3

### Differential Scanning Calorimeter (DSC) Analysis

The thermoplastic resin compositions of Examples 1 to 4 and Comparative Examples 1 to 9 were subjected to DSC analysis using a DSC under conditions that a heating rate was about 10° C./minute and a temperature was dropped after being increased up from about 25° C. to about 210° C., a glass transition temperature Tg, a melting temperature (Tm), and a cold crystallization temperature (Tcc). A part of the measurements is shown in Table 1 below.

TABLE 1

| | | | | | Property | | |
|---|---|---|---|---|---|---|---|
| | | | | | Glass | | |
| | Resin composition [wt %] | | | | transition | | |
| | | Graphene | | | temperature | | |
| | PLLA | oxide (GO) | EVA | HMDI | Tg [° C.] | Tm [° C.] | Tcc [° C.] |
| Example 1 | 87 | 1 | 10 | 2 | 62.3 | 165.1 | 121.3 |
| Example 2 | 87.5 | 0.5 | 10 | 2 | 62.8 | 165.2 | 122.4 |
| Example 3 | 87.75 | 0.25 | 10 | 2 | 62.9 | 165.1 | 116.9 |
| Example 4 | 87.9 | 0.1 | 10 | 2 | 61.6 | 166.4 | 131.1 |
| Comparative | 99 | 1 (Talc) | — | — | 64.7 | 170.5 | 95.9 |
| Example 4 | | | | | | | |
| Comparative | 88 | — | 10 | 2 | 62.1 | 164.7 | 96.9 |
| Example 7 | | | | | | | |
| Comparative | 89 | 1 (Talc) | 10 | — | 62.6 | 170.1 | 99.3 |
| Example 8 | | | | | | | |

### Evaluation Example 4

### Evaluation of Impact Resistance

According to the ASTM D256 evaluation method regarding the thermoplastic resin compositions of Examples 1 to 4 and Comparative Examples 1 to 9, raw materials were melted at a temperature of 210° C. by using a molding device (Thermo Scientific Co. Ltd., Haake Minijet Injection Molding System), and then, crystallized at a molding temperature of 100° C., thereby obtaining a sample of each of the thermoplastic resin compositions. Here, a thickness of the sample was about 3.2 mm. Next, a Notching machine (Instron Co. Ltd.) was used to perform notching of the sample, and then, an impact tester (Toyo Seiki Co. Ltd.) was used to perform an Izod impact test to measure Izod impact strength of the sample. The results are shown in Table 2 below.

### Evaluation Example 5

### Evaluation of Heat Resistance

In regard to the thermoplastic resin compositions of Examples 1 and 4 and Comparative Examples 1 to 9, raw materials were melted at a temperature of 210° C. by using a molding device (Thermo Scientific Co. Ltd., Haake Minijet Injection Molding System), and then, crystallized at a molding temperature of 100° C., thereby obtaining a sample of each of the thermoplastic resin compositions. Here, a thickness of the sample was about 3.2 mm.

Next, according to the ASTM D7028 evaluation method, a strain temperature at which a strain rate of the sample was 0.121% (i.e., heat distortion temperature) was measured when a force of 0.9 N was applied based on dynamic mechanical analysis (DMA) and a temperature was increased by 2° C./minute starting from room temperature. The results are shown in Table 2 below.

TABLE 2

| | | | | | Property | |
|---|---|---|---|---|---|---|
| | | | | | | Heat |
| | Resin composition [wt %] | | | | | distortion |
| | | Graphene | | | Izod Impact | temperature |
| | PLLA | oxide (GO) | EVA | HMDI | strength [J/m] | (DMA) [° C.] |
| Example 1 | 87 | 1 | 10 | 2 | 150 | 114.3 |
| Example 2 | 87.5 | 0.5 | 10 | 2 | 169 | 144 |
| Example 3 | 87.75 | 0.25 | 10 | 2 | 221 | 147.5 |
| Example 4 | 87.9 | 0.1 | 10 | 2 | 269 | 137.3 |
| Comparative | 100 | — | — | — | 49 | 67 |
| Example 1 | | | | | | |
| Comparative | 99 | 1 | — | — | 54 | 63.7 |
| Example 2 | | | | | | |
| Comparative | 99.5 | 0.5 | — | — | 57 | 72.4 |
| Example 3 | | | | | | |
| Comparative | 99 | 1 (Talc) | — | — | 30 | 134.8 |
| Example 4 | | | | | | |
| Comparative | 98 | 2 (Talc) | — | — | 49 | 146.4 |
| Example 5 | | | | | | |
| Comparative | 90 | — | 10 | — | 382 | 69 |
| Example 6 | | | | | | |
| Comparative | 88 | — | 10 | 2 | 146 | 75.3 |
| Example 7 | | | | | | |
| Comparative | 89 | 1 (Talc) | 10 | — | 273 | 99.4 |
| Example 8 | | | | | | |
| Comparative | 100(ABS) | — | — | — | 268 | — |
| Example 9 | | | | | | |

Referring to Table 2 and FIG. 2, the thermoplastic resin compositions of Examples 1 to 4 had improved impact resistance and/or improved heat resistance, compared with those of Comparative Examples 1 to 8.

As shown in FIG. 2, the denaturation of thermoplastic resin compositions of Examples 2 to 4 was inhibited at a temperature close to 60° C. to 110° C., showing improved heat resistance. In addition, the thermoplastic resin compositions of Examples 2 to 4 showed a similar impact resistance to that of the thermoplastic resin composition of Comparative Example 9.

As described above, according to the one or more of the above exemplary embodiments, an inorganic nanostructure, a chain extender, and optionally, a thermoplastic polymer having a low glass transition temperature Tg may be included in a thermoplastic resin composition, so as to improve both heat resistance and impact resistance of the thermoplastic resin composition.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermoplastic resin composition comprising:
polylactic acid (PLA);
an inorganic nanostructure; and
a chain extender.

2. The thermoplastic resin composition of claim 1, wherein the inorganic nanostructure is a two-dimensional (2D) carbonaceous nanostructure.

3. The thermoplastic resin composition of claim 1, wherein the inorganic nanostructure is graphene oxide.

4. The thermoplastic resin composition of claim 1, wherein the inorganic nanostructure is a modified inorganic nanostructure that is chemically coupled to the chain extender.

5. The thermoplastic resin composition of claim 1, wherein the thermoplastic resin contains about 1 wt % or less of the inorganic nanostructure.

6. The thermoplastic resin composition of claim 1, wherein the chain extender is a monomer, an oligomer, or a polymer, comprising at least one reactive functional group selected from a hydroxyl group, an amine group, an epoxy group, a glycidyl group, an isocyanate group, a carbodiimide group, and a carboxyl group.

7. The thermoplastic resin composition of claim 1, wherein the chain extender comprises at least two reactive functional groups.

8. The thermoplastic resin composition of claim 1, wherein the chain extender comprises 4,4′-diphenyl methane diisocyanate (MDI), 2,4- or 2,6-tolylene diisocyanate (TDI), 4,4′-dibenzyl diisocyanate, 1,3- or 1,4-phenylene diisocyanate, 1,5-naphthylene diisocyanate, zylene diisocyanate, ethylene diisocyanate, hexamethylene diisocyanate (HDI), lysine diisocyanate, isophorone diisocyanate(IPDI), 4,4′-dicyclohexylmethane diisocyanate, ethylene glycol, propylene glycol, 1,3-butylene glycol, 1,4-butanediol, 1,6-hexanediol, 3-methyl pentanediol, diethylene glycol, neopentyl glycol, 1,4-bis(hydroxylmethyl) cyclohexane, 1,4-bis(hydroxylethyl) benzene, 2,2-bis(4,4′-hydroxylcyclohexyl) propane, glycerin, trimethylolpropane, pentaerythritol, diglycerin, α-methylglucoside, sorbitol, zylitol, dipentaerythritol, glucose, fructose, sucrose, pyrogallol, hydroquinone, bisphenol A, bisphenol F, bisphenol S, ethylenediamine, hexamethylenediamine, diethylenetriamine, isophoron diamine, 4,4′-dicyclohexylmethane diamine, 4,4′-diaminodiphenylmethane, xylylene diamine, hydrazine, anhydrous succinic acid, anhydrous cyclohexane dicarboxylic acid, anhydrous phthalic acid, anhydrous maleic acid, anhydrous trimellitic acid, anhydrous pyromellitic acid, aryl glycidyl ether, stearic acid glycidyl ether, phenyl glycidyl ether, a bisphenol epoxy compound, a novolac epoxy compound, an epoxy-containing stylene-acrylic acid ester copolymer, (meta)acrylic acid glycidyl, modified phenylcarbodiimide, poly(tolyl carbodiimide), poly(4,4′diphenyl methanecarbodiimide), poly(3,3′-dimethyl-4,4′-biphenylene carbodiimide), polyparaphenylene carbodiimide, polymetaphenylene carbodiimide, poly(3,3′-dimethyl-4,4′-diphenylmethane carbodiimide), or a combination thereof.

9. The thermoplastic resin composition of claim 1, wherein the thermoplastic resin composition comprises about 2 wt % or less of the chain extender.

10. The thermoplastic resin composition of claim 1, further comprising a thermoplastic polymer having a lower glass transition temperature than that of the PLA.

11. The thermoplastic resin composition of claim 10, wherein the thermoplastic polymer is an olefin-based thermoplastic polymer.

12. The thermoplastic resin composition of claim 10, wherein the thermoplastic polymer is an ethylene vinyl acetate copolymer; an ethylene (meta)acrylic acid ester copolymer; and an olefin-based polymer comprising at least one reactive functional group selected from an acid anhydride group, a carboxyl group, an amino group, an imino group, an alkoxysilyl group, a silanol group, a silyl ether group, a hydroxyl group, an epoxy group, or a combination thereof.

13. The thermoplastic resin composition of claim 10, wherein the thermoplastic polymer is an ethylene vinyl acetate copolymer comprising about 60 wt % to about 75 wt % of a structural unit of ethylene, and about 25 wt % to about 40 wt % of a structural unit of vinyl acetate.

14. The thermoplastic resin composition of claim 10, wherein the thermoplastic polymer is from about 5.0 wt % to about 20 wt % of the total weight of the thermoplastic resin composition.

15. The thermoplastic resin composition of claim 10, wherein the thermoplastic resin composition comprises about 79 wt % to 92 wt % PLA, about 5 wt % to about 20 wt % of the thermoplastic polymer, about 0.1 wt % to about 1 wt % of the inorganic nanostructure, and about 0.1 wt % to 2 wt % of the chain extender.

16. A molded article comprising the thermoplastic resin composition of claim 1.

17. A method of preparing a thermoplastic resin composition, the method comprising:
preparing a master batch comprising polylactic acid (PLA) and graphene oxide; and
mixing the master batch with a chain extender.

18. The method of claim 17, wherein the mixing is performed by melt compounding or reactive compounding.

19. The method of claim 17, wherein the mixing is performed in a kneading extruder at a rate of about 10 rpm to about 100 rpm and at a temperature of about 190° C. to about 230° C.

20. The method of claim 17, wherein a ratio of carbon to oxygen in the graphene oxide (C/O ratio) is about 3 or less.
